(19) United States
(12) Patent Application Publication
(10) Pub. No.: US 2026/0214368 A1
(43) Pub. Date: Jul. 23, 2026

(54) TOUCH GESTURE CONTROL OF AN IN-EAR ELECTROSTATIC ACOUSTIC DEVICE

(71) Applicant: Waves Audio Ltd., Tel Aviv (IL)

(72) Inventors: Gabriel Zeltzer, Lapid (IL); Meir Shaashua, Tel Aviv (IL)

(21) Appl. No.: 19/023,436

(22) PCT Filed: Jul. 16, 2023
(86) PCT No.: PCT/IL2023/050741

§ 371 Date: Jan. 16, 2025

(30) Foreign Application Priority Data
Jul. 19, 2022 (GB) 22105380.1

(51) Int. Cl. H04R 1/10; G06F 3/01; G06F 3/041; G06F 3/16; H04R 19/02

(52) U.S. Cl. CPC H04R 1/1041; G06F 3/017; G06F 3/0416; G06F 3/165; H04R 1/1016; H04R 1/1075; H04R 19/02

(57) ABSTRACT

An earphone assembly including an electrostatic acoustic device. An audio signal is input to the electrostatic acoustic device. The membrane of the electrostatic acoustic device is configured to respond mechanically to a varying electric field responsive to an audio signal at the audio signal input. A detector is configured to detect a time-dependent displacement of the membrane responsive to an external stimulus on the housing and to issue a command in accordance with the detected time-dependent displacement of the membrane and the corresponding external stimulus.

### BACKGROUND

### 1. Technical Field

The present invention relates to electrostatic audio devices, including earphones and loudspeakers.

### 2. Description of Related Art

In the art of high fidelity sound reproduction, the electrostatic loudspeaker has received attention because of inherent excellent sound quality and smooth response over wide frequency ranges. In such devices, a flexible sound producing membrane is positioned near an electrode, or in the case of a push-pull arrangement, a pair of electrodes, one on either side of the membrane. A polarization potential is applied between the membrane and the electrodes, and an audio signal is superimposed on the electrodes, causing the membrane to move in response to the audio signal. Electrodes are acoustically transmissive so that sound produced by the moving membrane radiates outward through the electrode to the listening area.

Electrostatic devices are highly efficient both electrically and mechanically. Electrical impedance is high and decreases with increasing acoustic frequency. High electrical impedance results in very low operating currents and minimal electrical losses. Mechanically, there are no moving parts other than the moving membrane which is very light in weight. Electrostatic devices are therefore inherently more energy efficient than electrodynamic acoustic devices currently used in battery operated electronic devices.

### BRIEF SUMMARY

Various earphone assemblies and methods of control thereof are disclosed herein for an earphone assembly including an electrostatic acoustic device. An audio signal is input to the electrostatic acoustic device. The membrane of the electrostatic acoustic device is configured to respond mechanically to a varying electric field responsive to an audio signal at the audio signal input. A housing encloses the electrostatic acoustic device and a detector. The detector is configured to detect a time-dependent displacement of the membrane responsive to an external stimulus on the housing. A processor, operatively attached to the detector may be configured to issue a command selected from a group of previously defined commands. The selected command may be in accordance with the detected time-dependent displacement of the membrane and the corresponding external stimulus. The processor may be configured to select a mode of operation of the electrostatic acoustic device in accordance with the detected time-dependent displacement of the membrane and the corresponding external stimulus. A housing may enclose the electrostatic acoustic device and the detector. The housing may include a nozzle configured during in-ear operation for acoustic transmission from the membrane to an ear canal. The processor may be configured during the in-ear operation to detect a displacement of the membrane in response to the external stimulus including a touch gesture exerting pressure on the housing toward the ear canal. The processor may be configured during the in-ear operation to detect a time-dependent displacement of the membrane as an impulse response to the external stimulus including a finger tap gesture on the housing. The processor may be configured to distinguish between a finger tap on the housing by a fingernail and a finger tap on the housing by a pad of a finger. The processor may be configured during the in-ear operation to detect a time-dependent displacement of the membrane in response to the external stimulus including a touch gesture stroking a surface of the housing. The processor may be configured to distinguish between at least two directions of the stroking. The housing may include a surface with a roughness profile configured to produce a different membrane time-dependent displacement when rubbed in different directions.

### BRIEF DESCRIPTION OF THE DRAWINGS

The invention is herein described, by way of example only, with reference to the accompanying drawings, wherein:

FIG. 1A illustrates schematically a cross-sectional view of an electrostatic device, according to features of the present invention;

FIG. 1B is an isometric view, as viewed from the back, of an earphone according to features of the present invention;

FIG. 1C illustrates the earphone as viewed from the back as in FIG. 1B with a back cover removed, according to further features of the present invention;

FIG. 2 is an electronic block diagram of a feedback control system, according to features of the present invention for noise cancellation and/or adjustable acoustic transparency;

FIG. 2A illustrates an electronic block diagram of a proportional-integral-derivative controller (PID) controller of FIG. 2, according to conventional art.

FIG. 3 is a system diagram including an electrostatic acoustic device and driver thereof for simultaneous dual use as a loudspeaker and a microphone;

FIG. 4A illustrates an electronic block diagram of electrostatic acoustic device and driver thereof for use in FIG. 2 and FIG. 3;

FIG. 4B illustrates an alternative block diagram driver of the electrostatic acoustic device and driver, according to features of the present invention for use in FIGS. 2 and 3;

FIG. 5 is a flow diagram of a method, illustrating features of the present invention.

The foregoing and/or other aspects will become apparent from the following detailed description when considered in conjunction with the accompanying drawing figures.

### DETAILED DESCRIPTION

Reference will now be made in detail to features of the present invention, examples of which are illustrated in the accompanying drawings, wherein like reference numerals refer to like elements throughout. The features are described below to explain the present invention by referring to the figures.

By way of introduction, different aspects of the present invention may be directed to an in-ear electrostatic acoustic device which may be used in different modes of operation. The in-ear electrostatic acoustic device may be configured as an in-ear earphone and may include or interface with an audio player and include functions such as play, stop, move forward or backward on a playlist, etc. Alternatively, the in-ear device may be operated as a hearing aid. According to the embodiments of the present invention, touch gestures during in-ear operation on a housing of the in-ear electrostatic acoustic device may be detected and used to control operation of the device.

Features of the present invention may include an earphone housing with one or more apertures to provide an acoustically transmissive back, an integrated power source, e.g. battery with power circuitry and audio circuitry integrated within the in-ear housing. Two main modes of operation are available i) a closed loop control mode which includes 1) a noise cancellation mode in which feedback to the electro-acoustic device may be configured to cancel ambient sound or noise and/or 2) an adjustable acoustic transparency mode, that is the extent the user hears ambient sound may be adjusted by tuning feedback in the control circuit. The second main mode of operation is ii) an open loop mode which allows extraction of a signal responsive to time dependent displacement of the membrane of the electrostatic speaker. In mode ii) the electrostatic speaker may be used simultaneously as a microphone and a loudspeaker, and sounds may be generated by touch gestures on the housing of the in-ear device to control operation of the device. According to a feature of the present invention, a touch gesture may be used to switch the device between main operational modes i) and ii).

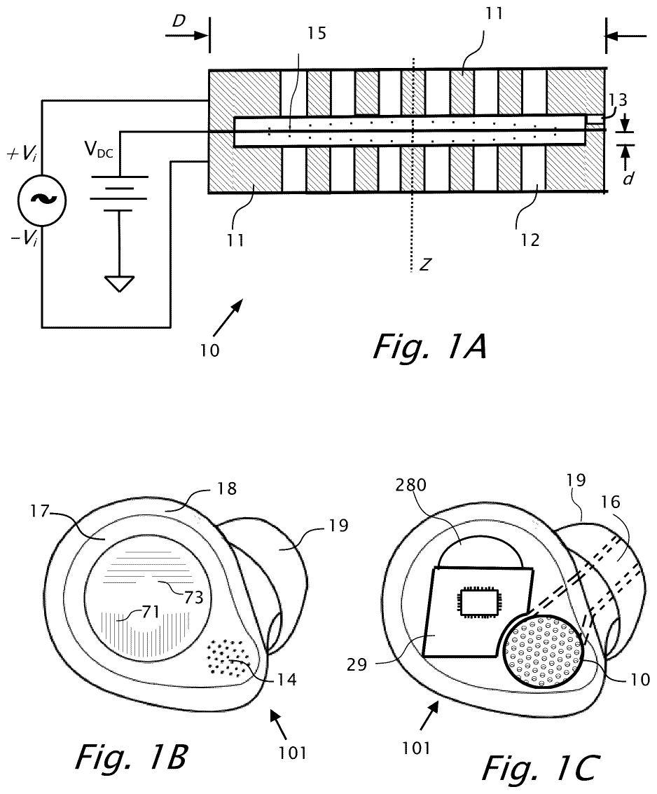

Referring now to the drawings, reference is now made to FIG. 1A, which illustrates schematically an electrostatic acoustic device 10, according to features of the present invention. Vertical axis Z is shown through a centre of acoustic device 10. A tensioned membrane 15 is supported, by edges of electrodes 11, essentially in a plane perpendicular to vertical axis Z. Membrane 15 may be impregnated with a conductive, resistive and/or electrostatic material so that membrane 15 responds mechanically to a changing electric field. The central regions of electrodes 11 are mounted proximate to, e.g. in parallel to, membrane 15, nominally equidistant, at a distance d, e.g. 20-500 micrometres from membrane 15. Electrodes 11 as illustrated may be perforated with apertures 12 transmissive to sound waves emanating from membrane 15 when electrostatic acoustic device 10 is operating. Alternatively or in addition one or more side ports 13 may pass sound waves from air surrounding membrane 15 to outside device 10. During operation of electrostatic acoustic device 10, a constant direct current (DC) bias voltage, e.g. +V_{DC}=+100 to +1000 volts, may be applied using a conductive contact to membrane 15. A non-inverted voltage signal +Vᵢ may be applied to one of electrodes 11 and an identical but inverted voltage signal −Vᵢ may be applied to the other electrode 11. Alternatively, a voltage signal Vᵢ may be applied to membrane 15 and electrodes 11 may be biased at ±V_{DC}/2. Voltage signals ±Vᵢ may vary at audio frequencies, nominally between 20-20,000 Hertz. Dotted lines illustrate schematically membrane 15 moving in response to a changing electric voltage due to voltage signals ±Vᵢ.

Reference is now also made to FIG. 1B, an isometric view, as viewed from the back, of an earphone 101 according to features of the present invention. A housing of earphone 101 includes one or more assembled parts, back-housing 17 and front-housing 18. Back-housing 17 may include one or more apertures 14 or through-holes which provide acoustic transparency from the ambient through apertures 14, through apertures 12 of electrode 11 to membrane 15 of electro-acoustic device 10.

Reference is now also made to FIG. 1C, which illustrates earphone 101 with back-housing 17 removed, according to features of the present invention. An acoustic seal 19 may be removably fitted over a nozzle 16. Acoustic seal 19 is intended to fit and acoustically seal inside an ear canal of a user. Interior of nozzle 16 is a channel which leads to electrostatic acoustic device 10 which includes membrane 15 sealed therein (not shown). Circuit board 29 may include a DC-DC converter which provides direct current (DC) bias voltage(s) V_{DC} from a voltage input from a battery 280. Circuit board 29 may include circuits for providing audio voltage signals ±Vᵢ and other circuitry as disclosed herein or otherwise desired.

Thus, in embodiments of the present invention including electrostatic acoustic device 10 being used as an earphone and sealed into the ear canal, the mechanical displacement of the ear drum may become coupled with the mechanical displacement of membrane 15. Voice of a user may be transmitted internally by bone conduction to the ear drum and by the internal coupling to membrane 15 enabling membrane 15 for use as a microphone. When used as a microphone, membrane 15 is sensitive to ambient sound as well as sounds generated by touch gestures on housing 17,18.

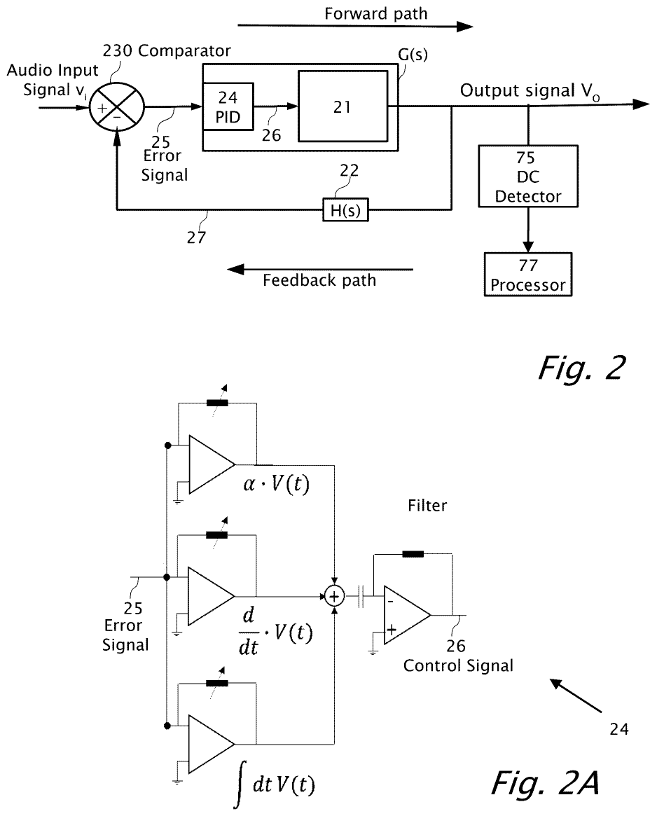

Reference is now made to FIG. 2, which illustrates a control circuit, according to features of the present invention. In the forward path, G(s) represents open loop gain of the control circuit including system 21, where s may be a complex variable representing an alternating voltage signal in the form A(e^{iωt}+φ) where A represents an amplitude, ω=2πf represents an angular frequency, where f represents a frequency in Hertz and φ represents a phase shift in radians.

Reference is now also made to FIG. 2A, which illustrates a Proportional, Integral and Derivative (PID) block 24, according to conventional art. The feedback loop may include in the forward path G(s) Proportional, Integral and Derivative (PID) block 24. Block 24 may include relative to error signal 25, a proportional gain, a differential and/or integration in linear combination as well as frequency filtering to output a control signal 26.

Referring back to FIG. 2, in the feedback path, block 22 represents transform function H(s) of an output voltage signal Vₒ. The feedback path output from feedback block 22 may output a feedback signal 27, which may be subtracted by comparator 230 from the input signal vᵢ to produce an error signal 25. Responsive to error signal 25, PID controller 24 outputs control signal 26 to a controller block 21 so that the output signal Vₒ approaches a set point. Overall transfer function of system 20, voltage output Vₒ divided by voltage input vᵢ of controller 21 may be modeled by equation 1:

$$\frac{{V}_{o}}{{v}_{i}} = \frac{G ( s )}{1 + G ( s ) \cdot H ( s )} \qquad ( 1 )$$

When input signal vᵢ is nominally zero, feedback signal 27 becomes error signal 25. Alternatively, instead of comparator 23, a signal combiner 23 may be equivalently used and feedback block 22 appropriately transforms, e.g. inverts, voltage output signal Vₒ to feedback signal 27 which is combined into error signal 25.

Stability of control system 20 is contingent upon the denominator 1+G(s)·H(s) having sufficiently large absolute value and/or being non-zero. It is well known that in a resonant system 21, including a damped harmonic oscillator with an external drive that the response of an oscillator is in phase (i.e. φ≈0) with the external drive for driving frequencies well below the resonant frequency, is in phase quadrature (i.e. φ≈π/2) at the resonant frequency, and is anti-phase (i.e. φ≈π) for frequencies well above the resonant frequency. If control system 21 includes a resonance and an oscillating energy source, then in order to maintain stability, the oscillating energy source operates either below or above the resonant frequency without ever crossing the resonant frequency. In case of resonance frequency cross-over, a phase shift filter may be added to mitigate the phase response discontinuity.

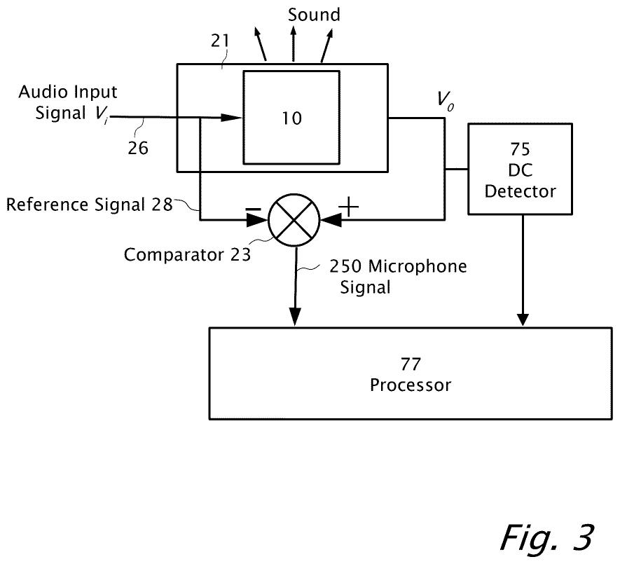

Reference is now made to FIG. 3, a simplified electronic system block diagram including electrostatic acoustic device 10, in an open loop mode of operation, for simultaneous operation as a speaker and as a microphone. Block 21 represents a driver or electronic circuitry which inputs voltage signal Vᵢ to drive electrostatic acoustic device 10 causing sound to emanate from moving membrane 15. A reference signal 28 may be split or tapped from input audio signal Vᵢ and input to a comparator 23. Block 21 detects a signal proportional to or responsive to mechanical motion of membrane 15 and outputs a signal, e.g. voltage Vₒ, responsive to membrane 15 motion. Voltage output signal Vₒ is a second input to comparator 23. Comparator 23 is configured to compare, e.g. subtract, reference signal 21 from output voltage signal Vₒ which with appropriate signal processing, may extract a microphone signal 250 responsive to vibrations of membrane caused by an ambient sound or a sound generated by touch gestures on housing 17,18 of in-ear device 101.

Detection of a signal proportional to or responsive to mechanical motion of membrane 15 may be performed by various detection methods known in the art. Detection of a change in electrostatic current or change in capacitance between membrane 15 and electrodes 11 is described herein. Other detection methods for measuring membrane 15 motion may be used, according to different embodiments of the present invention including optical sensors, external field gradient (force) detection such as electrostatic or magnetic field gradient using a Hall effect magnetic sensor, by way of example.

For any detection method responsive to membrane 15 motion, a microphone signal 250 may be extracted by subtracting or comparison with time-dependent motion of membrane 15 response to the audio input signal Vᵢ. Subtraction may be performed in the time domain by digital signal processing with an appropriate level adjustment and/or time delay. Alternatively, subtraction may be performed in the frequency domain by transforming the signals, e.g. short time Fourier transform, performing the subtraction in the frequency domain and performing an inverse e.g. Fourier transform back to the time domain to extract a microphone signal.

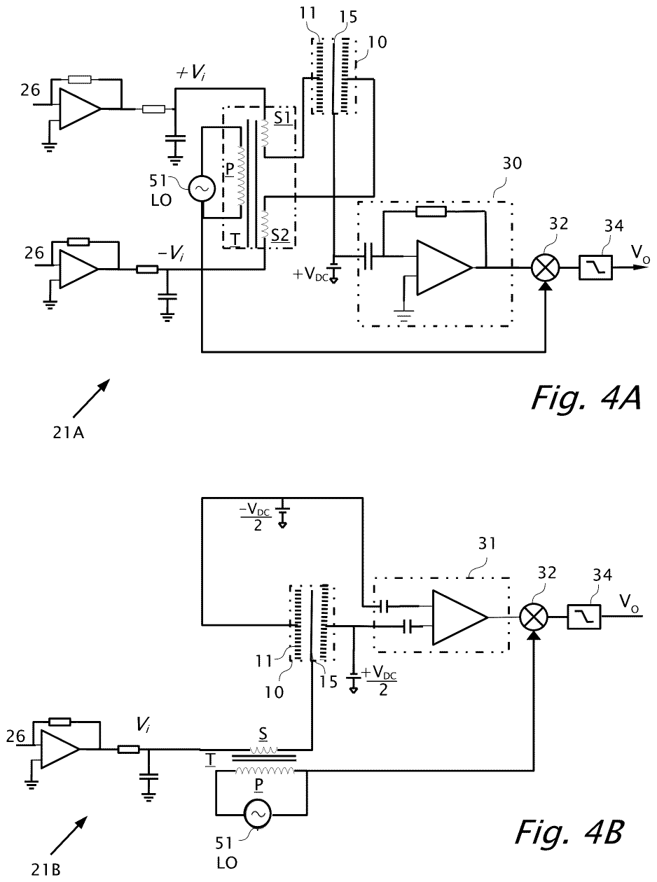

Reference is now made to FIG. 4A, which illustrates schematically a circuit 21A, an alternative for system 21 in FIGS. 2 and 3, in further detail, according to features of the present invention. Driver 21A includes electrostatic acoustic device 10 which may be configured to receive a high voltage audio input +Vᵢ at first electrode 11 and an inverted high voltage audio input −Vᵢ at second electrode 11 varying at audio frequencies intended for transduction into sound by electrostatic acoustic device 10.

A probe signal from a local oscillator (LO) 51 at radio frequency, e.g. 0.1-20 megahertz may be coupled between the primary windings P of a transformer T. Audio signal +Vᵢ and inverted audio signal −Vᵢ are fed respectively to electrodes 11 through series-connected secondary windings S1 and S2 of transformer T. Audio signals ±Vᵢ may be high voltage signals. Alternatively, audio signals ±Vᵢ may be low voltage signals up to ~±20V. A direct current voltage bias +V_{DC} may be applied to membrane 15. The probe signal produces a current which has a magnitude determined by the characteristic reactance of the electric circuit formed by the membrane 15 and electrode 11, essentially a variable capacitor. Probe signal from local oscillator (LO) 51 may also be combined with the voltage output of amplifier 30 at signal combiner/multiplier 32. Signal combiner/multiplier 32 outputs to a low pass filter 34 which demodulates and transmits voltage output signal Vₒ, varying at audio frequencies. System 21B is a homodyne detection circuit which uses local oscillator 51 as a reference which is multiplied with the measured signal output of amplifier 30 at the same frequency. The base band or DC component of this multiplication includes the signal which is frequency converted from a narrow band around LO 51 frequency detected with a very high signal to noise ratio.

Membrane 15 may respond mechanically to ambient sound waves as device 10 may behave as a microphone. In response to ambient sound, distance d (FIG. 1) between membrane 15 and electrodes 11 changes resulting in a change of capacitance C of electrostatic acoustic device 10. A changing current i(t) due to ambient sound may be sensed using a transimpedance amplifier 30, approximated by:

$$i ( t ) = {V}_{D C} \frac{dC}{dt} \qquad ( 2 )$$

Alternatively, a charge amplifier 30 may be considered, instead of a transimpedance amplifier, which integrates current i(t) to sense charge Q(t) which varies with changing capacitance of electrostatic acoustic device 10, and the sensed charge is converted to an output voltage signal Vₒ.

Amplifier 30 may be configured to be inverting or non-inverting, and may have a band-pass including audio frequencies, 20-20000 Hertz.

An advantage of using radio frequency is in the fact that radio frequency does not produce a perceptible mechanical motion but is modulated by the electrical change in capacitance which is related to the mechanical motion produced when an audio signal and/or ambient sound is present. In addition, the radio frequency amplitude modulated signal has a higher signal-to-noise ratio with respect to the total capacitance change of the device when compared to the current induced by the direct capacitance change shown in relation (2).

Reference is now made to FIG. 4B, which illustrates schematically another alternative 21B for block 21 in FIGS. 2 and 3, according to different features of the present invention. In controller 21B, audio voltage Vᵢ may be applied to membrane 15. A probe signal from a local oscillator 51 may also be induced onto membrane 15 using a transformer T with primary P connected in parallel with local oscillator 51 and secondary S connected in series between audio voltage Vi and membrane 15. Bias voltage V_{DC} may be symmetrically applied on electrodes 11 with −V_{DC}/2 on a first electrode 11 and +V_{DC}/2 applied on a second electrode 11. A differential amplifier 31 may be used with inputs capacitively coupled respectively to electrodes 11. The voltage output of differential amplifier 31 varies with capacitance of device 10. Probe signal from local oscillator (LO) 51 may also be combined with the voltage output of differential amplifier 31 at signal combiner/multiplier 32. Signal combiner/multiplier 32 outputs to a low pass filter 34 which demodulates and transmits voltage output signal Vₒ, varying at audio frequencies. Differential amplifier 31 may be implemented using Texas Instruments/Burr-Brown™ INA105. According to features of the present invention controller 21B has an advantage over controller 21A because when a single high voltage audio signal Vᵢ is used, one and not two high voltage input amplifiers are required.

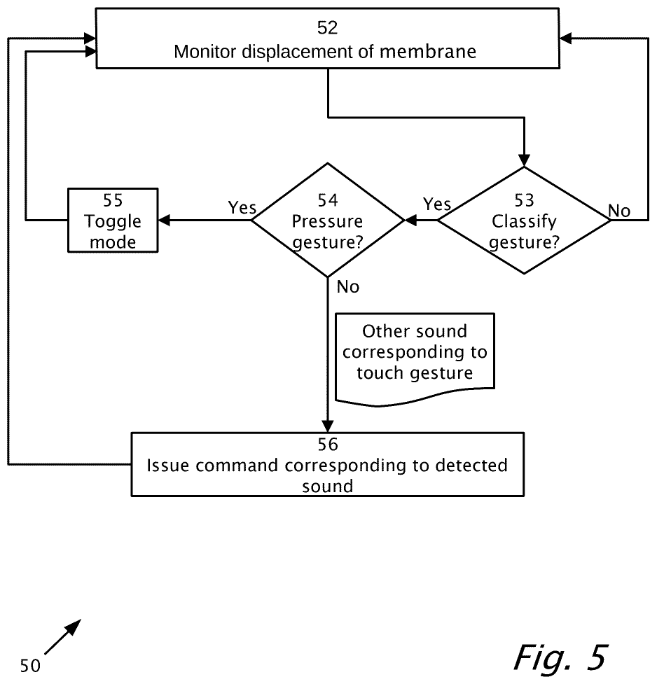

Reference is now also made to FIG. 5 is a flow diagram of a method 50, illustrating features of the present invention. Referring again to FIGS. 2 and 3, a detector circuit 75 is shown connected to a processor 77 configured to monitor (step 52) a time-dependent displacement of membrane 15. The time-dependent displacement results in a time dependent change in capacitance which may be detected by processing respective outputs of detector 75 and/or microphone signal 250 as shown in FIG. 3.

Processor 77 may be configured to classify (step 53) the time-dependent displacement as corresponding to one of a set of previously defined touch gestures. Processor 77 and detector 75 may be configured to detect (decision block 54) a pressure gesture on housing 17,18 of in-ear device 101 during operation. Pressure in the direction of the inner ear during e.g. 100 to 1000 milliseconds may cause membrane 15 to displace outward on the average as in-ear device 101 is pushed slightly into the ear while both the eardrum and membrane 15 are sealed in the ear canal and while aperture 14 in back-housing 17 allows for pressure equilibration between the membrane and the ambient atmosphere. According to a feature of the present invention, if a pressure gesture is detected (decision block 54) then operational mode of in-ear device 101 may toggle (step 55) between modes (i) noise cancellation/adjust acoustic transparency; (FIG. 2) and (ii) simultaneous operation as a microphone and speaker. (FIG. 3) While in mode (ii), microphone signal may be processed by processor 77 and processor 77 may issue (step 56) respective commands depending on the classification microphone signals from specific sounds generated by the user by touch gestures.

Reference is now made again to FIG. 1B which shows further features of the present invention. Processor 77 may be configured during in-ear operation to detect a time-dependent displacement of the membrane in response to an external stimulus including a touch gesture by a user stroking a surface of housings 17 or 18. Various touch gestures may include an impulse, e.g. a finger tap gesture on the exterior housing 17. Processor 77 may be configured, ie. previously trained, to distinguish between a finger tap on the housing by a fingernail and a finger tap on the housing by a pad of a finger. Housings 17 and/or 18 may include roughness or a spatial periodicity 71, 73 which when stroked makes a characteristic sound which may cause a characteristic time dependent displacement of membrane 15 which may be sensed by detector 75 and classified by processor 77 as a control command. As shown in device 101, of FIG. 1B, housing 17 is shown with two examples of surface roughness 71 and 73 with different periodicity and different directions of the periodicity. The periodicity or amount of roughness changes the frequency content of the characteristic sounds caused by stroking housings 17, 18. Stroking by the user housing 17 optionally in different places 71 and 73 in different directions may result in two different commands issued by processor 77.

The term “homodyne” as used herein refers to a method of detection/demodulation of a signal which is phase and/or frequency modulated onto an oscillating signal by combining with a reference oscillation.

The term “ambient” as used herein refers to vicinity of the membrane of the electrostatic acoustic device.

The term “driver” as used herein is an electronic circuit configured to electrically bias, input and/or output signals to and from an electrostatic acoustic device.

The term “transimpedance amplifier” as used herein converts current to voltage. Transimpedance amplifiers may be used to process current output of a sensor to a voltage signal output.

The term “charge amplifier” as used herein converts a time varying charge to a voltage output typically by integrated a time varying current signal.

The term “audio” or “audio frequency” refers to an oscillation rate of an alternating electric current or voltage or of a magnetic, electric or electromagnetic field or mechanical system in the frequency range 0-20,000 Hertz.

The term “audio signal”, “audio output”, “audio output signal” as used herein refer to an electrical signal varying essentially at audio frequency.

The term “radio frequency” (RF) is the oscillation rate of an alternating electric current or voltage or of a magnetic, electric or electromagnetic field or mechanical system in the frequency range from around twenty thousand times per second (20 kHz) to around three hundred billion times per second (300 GHz).

The transitional term “comprising” as used herein is synonymous with “including”, and is inclusive or open-ended and does not exclude additional element or method steps not explicitly recited. The articles “a”, “an” is used herein, such as “a circuit” or “an electrode” have the meaning of “one or more” that is “one or more circuits”, “one or more electrodes”.

All optional and preferred features and modifications of the described embodiments and dependent claims are usable in all aspects of the invention taught herein. Furthermore, the individual features of the dependent claims, as well as all optional and preferred features and modifications of the described embodiments are combinable and interchangeable with one another.

Although selected features of the present invention have been shown and described, it is to be understood the present invention is not limited to the described features.

1. An earphone assembly comprising:
an electrostatic acoustic device including a membrane;
an audio signal input to the electrostatic acoustic device, wherein the membrane is configured to respond mechanically to a varying electric field responsive to an audio signal at the audio signal input;
a detector; and
a housing enclosing the electrostatic acoustic device and the detector;
wherein the detector is configured to detect a time-dependent displacement of the membrane responsive to an external stimulus on the housing.

2. The earphone assembly of claim 1, further comprising:
a processor operatively attached to the detector, wherein the processor is configured to issue a command selected from a group consisting of previously defined commands, the selected command in accordance with the detected time-dependent displacement of the membrane and the corresponding external stimulus.

3. The earphone assembly of claim 1, further comprising:
a processor operatively attached to the detector, wherein the processor is configured to select a mode of operation of the electrostatic acoustic device in accordance with the detected displacement of the membrane and the corresponding external stimulus.

4. The earphone assembly of claim 1, further comprising:
wherein the housing further includes a nozzle configured during in-ear operation for acoustic transmission from the membrane to an ear canal.

5. The earphone assembly of claim 4, wherein the processor is configured during the in-ear operation to detect a time-dependent displacement of the membrane in response to the external stimulus including a touch gesture exerting pressure on the housing toward the ear canal.

6. The earphone assembly of claim 4, wherein the processor is configured during the in-ear operation to detect a time-dependent displacement of the membrane as an impulse response to the external stimulus including a finger tap gesture on the housing.

7. The earphone assembly of claim 6, wherein the processor is configured to distinguish between a finger tap on the housing by a fingernail and a finger tap on the housing by a pad of a finger.

8. The earphone assembly of claim 4, wherein the processor is configured during the in-ear operation to detect a time-dependent displacement of the membrane in response to the external stimulus including a touch gesture stroking a surface of the housing.

9. The earphone assembly of claim 8, wherein the processor is configured to distinguish between at least two directions of the stroking.

10. The earphone assembly of claim 9, wherein the housing includes a surface with a roughness profile configured to produce a different time-dependent membrane displacement when rubbed in different directions.

11. A method for enabling control of an earphone assembly including an electrostatic acoustic device, a detector and a housing, wherein the electrostatic acoustic device includes a membrane and an audio signal input, wherein the housing encloses the electrostatic acoustic device and the detector, the method comprising:
inputting at the audio signal input an audio signal to the electrostatic acoustic device;
configuring the membrane to respond mechanically to a varying electric field responsive to the audio signal; and
detecting a time-dependent displacement of the membrane responsive to an external stimulus on the housing.

12. The method of claim 11, further comprising:
issuing a command selected from a group consisting of previously defined commands, the selected command in accordance with the detected time-dependent displacement of the membrane and the corresponding external stimulus.

13. The method of claim 11, further comprising:
selecting a mode of operation of the electrostatic acoustic device in accordance with the detected displacement of the membrane and the corresponding external stimulus.

14. The method of claim 11,
wherein the housing includes a nozzle configured during in-ear operation for acoustic transmission from the membrane to an ear canal.

15. The method of claim 14, further comprising
during the in-ear operation, detecting a time-dependent displacement of the membrane in response to the external stimulus including a touch gesture exerting pressure on the housing toward the ear canal.

16. The method of claim 14, further comprising:
during the in-ear operation, detecting a time-dependent displacement of the membrane as an impulse response to the external stimulus including a finger tap gesture on the housing.

17. The method of claim 16, further comprising:
distinguishing between a finger tap on the housing by a fingernail and a finger tap on the housing by a pad of a finger.

18. The method of claim 14, further comprising:
during the in-ear operation, detecting a time-dependent displacement of the membrane in response to the external stimulus including a stroking of a surface of the housing.

19. The method of claim 18, further comprising:
distinguishing between at least two directions of the stroking.

20. The method of claim 19, wherein the housing includes a surface with a roughness profile configured to produce a different membrane displacement when rubbed in different directions.
